(19) United States
(12) Patent Application Publication
(10) Pub. No.: US 2019/0285920 A1
(43) Pub. Date: Sep. 19, 2019

(54) DISPLAY PANEL

(71) Applicant: SHARP KABUSHIKI KAISHA, Osaka (JP)

(72) Inventors: YASUHIRO KUROE, Sakai City (JP); YOSHIHIRO SHIOAKU, Sakai City (JP); NORIYUKI OHASHI, Sakai City (JP)

(21) Appl. No.: 16/352,115

(22) Filed: Mar. 13, 2019

(30) Foreign Application Priority Data
Mar. 16, 2018 (JP) 2018-049337

(51) Int. Cl. G02F 1/1345; G06K 19/06

(52) U.S. Cl. CPC G02F 1/1345; G06K 19/06037

(57) ABSTRACT

A display panel includes a first substrate, a second substrate that is pasted together with the first substrate so as to overlap the first substrate and is larger than the first substrate, and a driver mounting portion that is included in a part of the second substrate so as not to overlap the first substrate and on which a driver driving the display panel is mounted, and the driver mounting portion having an identification symbol for identifying the display panel.

### CROSS REFERENCE TO RELATED APPLICATION

This application claims priority from Japanese Patent Application No. 2018-049337 filed on Mar. 16, 2018. The entire contents of the priority application are incorporated herein by reference.

### TECHNICAL FIELD

The technology described herein relates to a display panel and relates particularly to placement of an identification symbol on the display panel.

### BACKGROUND

In many cases, a display panel has identification symbols placed thereon for identifying the display panel so that the identification symbols allow tracking a manufacturing process history. However, reduction of the size of a panel frame for the display panel in recent years has lead to a shortage of areas in which the identification symbols are placed. This may result in a case where some of the identification symbols cannot be placed and therefore the idea of placing them must be given up. To deal with such a problem, one example of a display panel has an identification symbol disposed in an area overlapping a conductive member in a plan view, and the conductive member is disposed between a pair of substrates and electrically connects the substrates.

### SUMMARY

However, according to such a display panel, because the identification symbol is disposed in a part of the area where the pair of substrates are electrically connected, lines are obviously present in the area and therefore design to avoid interference between the identification symbol and the lines must be devised. Besides, one of the pair of substrates that is located closer to a display surface has a shading unit (black matrix). Because of this, the identification symbol can always be visually recognized only through the substrate opposite to the substrate located closer to the display surface.

The technology described herein is completed in view of the above circumstances and an object of the technology described herein is to provide a display panel that is practically used and includes an additional space for placing an identification symbol and where the identification symbol can be placed relatively easily and the placed identification symbol can be visually recognized easily.

A display panel according to the technology described herein includes a first substrate, a second substrate that is pasted together with the first substrate so as to overlap the first substrate and is larger than the first substrate, and a driver mounting portion that is included in a part of the second substrate so as not to overlap the first substrate and on which a driver driving the display panel is mounted, and the driver mounting portion having an identification symbol for identifying the display panel.

According to the display panel configured in the above manner, a space for placing the identification symbol is secured in an area in which the driver is mounted. This allows a space on the second substrate to be used effectively. In addition, for example, a configuration in which the identification symbol can be visually recognized from both front side and backside can be achieved before the driver is mounted. Even after the driver is mounted, the identification symbol can be visually recognized from a side opposite to the driver. Even if the size of the panel frame for the display panel is further reduced, the display panel of the present technology allows the identification symbol to be placed securely. Identification symbols placed on the display panel configured in the above manner include various types of symbols, such as characters/figures, marks, and two-dimensional bar codes.

The technology described herein provides a practical display panel that has an additional space for placing an identification symbol and where the identification symbol can be placed relatively easily and the placed identification symbol can be visually recognized easily.

### BRIEF DESCRIPTION OF THE DRAWINGS

FIG. 1 is a plan view of a liquid crystal panel according to a first embodiment.

FIG. 2 is a sectional view of the liquid crystal panel according to the first embodiment.

FIG. 3 is an enlarged plan view of a CF substrate non-overlapping portion of an array substrate shown in FIG. 1.

FIG. 4 schematically illustrates a section of the CF substrate non-overlapping portion of the array substrate shown in FIG. 1.

FIG. 5 is an enlarged sectional view of a diver mounting portion shown in FIG. 3.

FIG. 6 is an enlarged sectional view of a driver mounting portion of a liquid crystal panel according to a second embodiment.

FIG. 7 is an enlarged plan view of a CF substrate non-overlapping portion of an array substrate of a liquid crystal panel according to a third embodiment.

FIG. 8 is a sectional view (section taken along an A-A line in FIG. 7) of a ground portion of the liquid crystal panel according to the third embodiment.

### DETAILED DESCRIPTION

Some embodiments of the technology described herein will hereinafter be described in detail with reference to drawings. The technology described herein is not limited to the embodiments described below and may be carried out in various modified or improved modes based on knowledge of those who skilled in art.

### First Embodiment

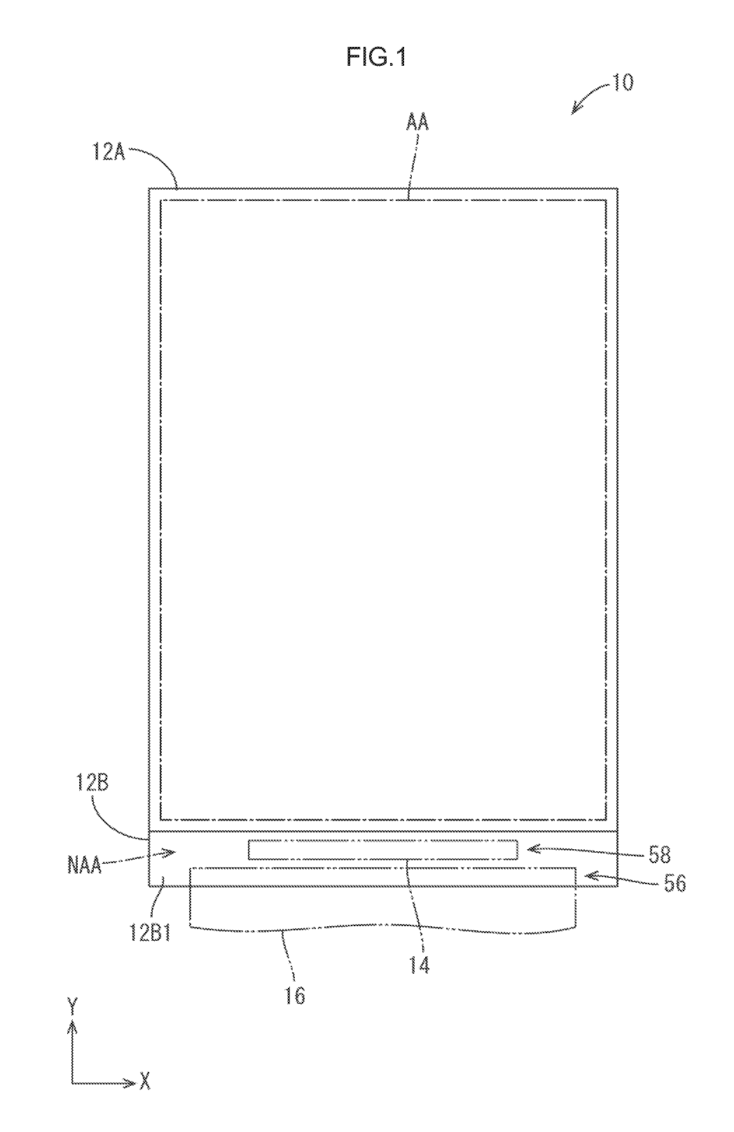

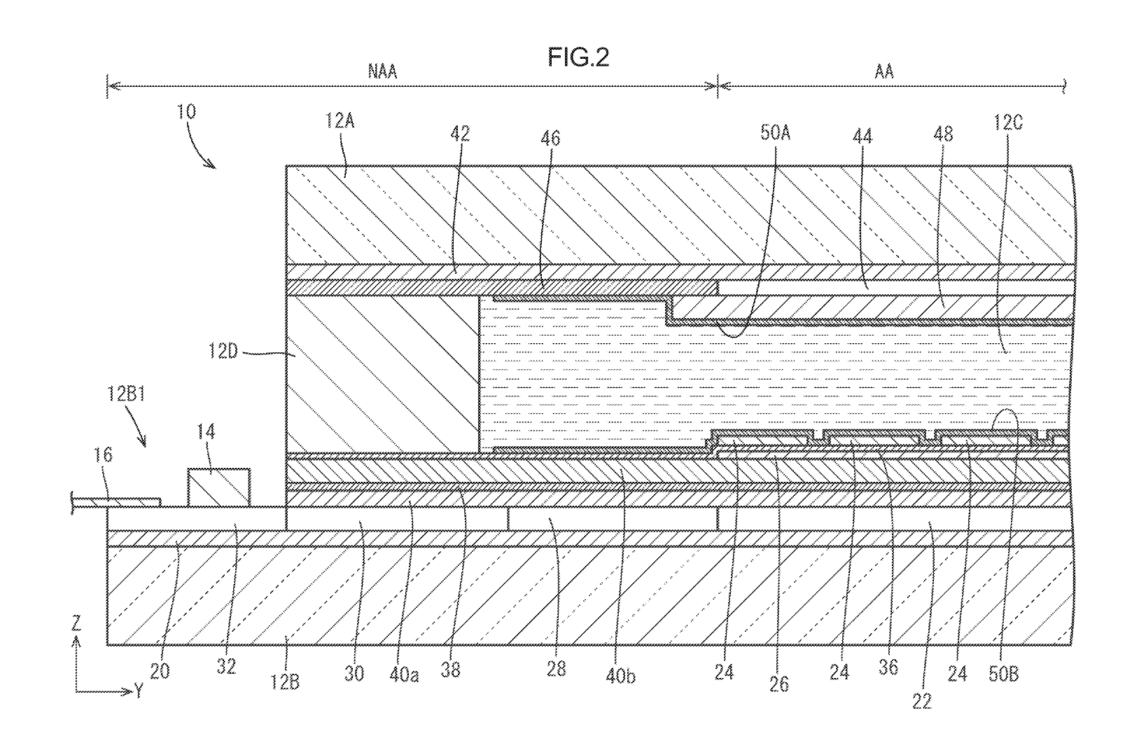

As shown in FIG. 1, a liquid crystal panel 10 according to a first embodiment is of a longitudinally elongated rectangle as a whole. A display surface of the liquid crystal panel 10 is divided into a display area (active area) AA, in which an image is displayed, and a non-display area (non-active area) NAA, which is of a frame shape encircling the display area AA and in which no image is displayed. In FIG. 1, a single-dot chain line represents the outline of the display area AA, and an area outside the single-dot chain line is the non-display area NAA. The accompanying drawings each have the X-axis, Y-axis, and Z-axis drawn therein such that the X-axis, Y-axis, and Z-axis indicate the same X-axis direction, Y-axis direction, and Z-axis direction, respectively, in each of the drawings. In each drawing, the direction of short sides of the liquid crystal panel 10 matches the direction of the X-axis while the direction of long sides of the same matches the direction of the Y-axis. FIG. 2 provides a reference based on which the vertical direction (front-to-rear direction) is defined. Hence the upper side in FIG. 2 may be referred to as a front side, and the lower side in FIG. 2 may be referred to as a back side.

The liquid crystal panel 10 is constructed by pasting a pair of substrates 12A and 12B together. A substrate disposed on the front side is a CF substrate (counter substrate) 12A, and a substrate disposed on the back side is an array substrate (substrate for a display device or active matrix substrate) 12B. As it will be described in detail later, these CF substrate 12A and array substrate 12B are each constructed by stacking a plurality of films on a substantially transparent glass substrate by a known photolithography process, etc. As shown in FIG. 1, the array substrate 12B is longer in dimension in the direction of long sides (Y-axis direction) than the CF substrate 12A, and is pasted such that the array substrate 12B sticks out in the direction of long sides relative to the CF substrate 12A. Thus, according to this embodiment, the CF substrate 12A is defined as a first substrate and the array substrate 12B is defined as a second substrate. A part of array substrate 12B that does not overlap the CF substrate 12A is defined as a CF substrate non-overlapping portion 12B1, on which a driver (IC chip) 14 and a flexible board 16 are mounted as components for supplying various signals.

The internal structure of the liquid crystal panel 10 will then be described, referring to FIG. 2. Various elements related to the internal structure are illustrated in simplified forms in FIG. 2. Between the pair of substrates 12A and 12B counter to each other, a liquid crystal layer 12C including liquid crystal molecules whose optical properties are changed by an electric field applied thereto and a seal 12D that seals up the liquid crystal layer 12C are interposed. The seal 12D is disposed on a peripheral end, which is the non-display area NAA between the pair of substrates 12A and 12B, and extends along the whole of the peripheral end, thus having a rectangular frame shape (endless loop) in a plan view (see FIG. 1). At the peripheral end of the pair of substrates 12A and 12B, the seal 12D maintains a gap (cell gap) having a thickness equal to that of the liquid crystal layer 12C. In the display area AA, a photospacer for maintaining the cell gap is interposed between the pair of substrates 12A and 12B.

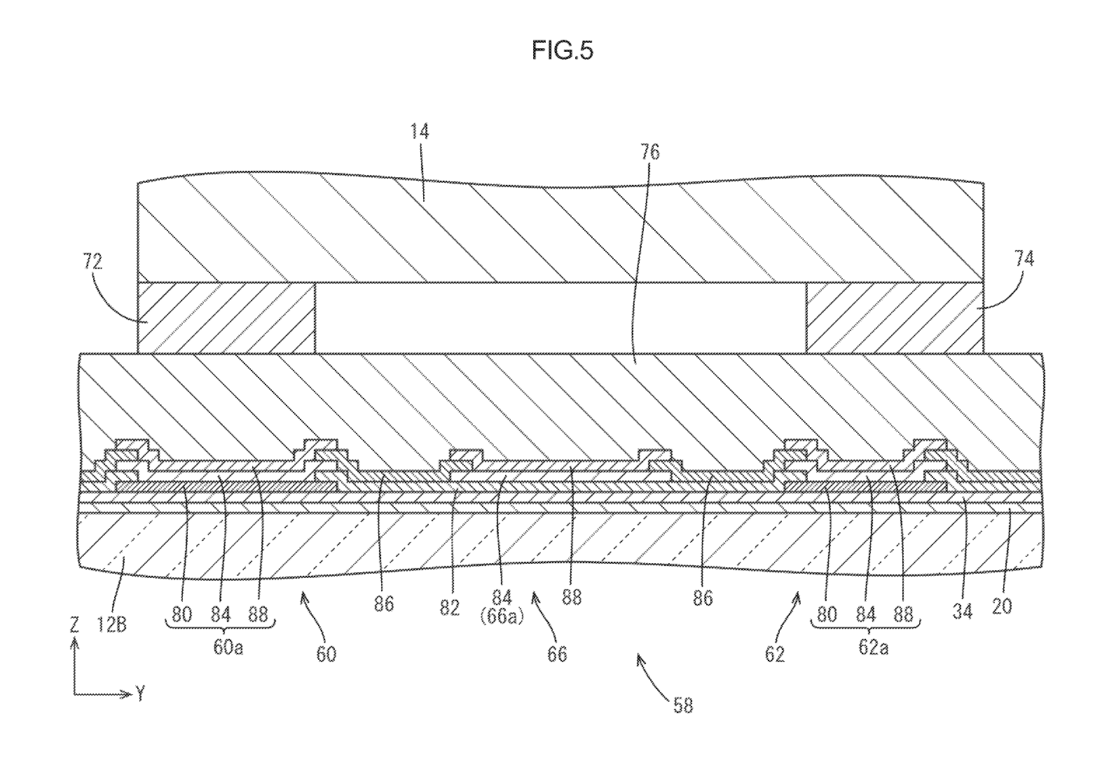

In the array substrate 12B, a base coat 20 is formed on a substantially transparent glass substrate, and on the base coat 20, a pixel circuit 22, pixel electrodes 24, and a common electrode 26 are arranged in the display area AA while a peripheral circuit 28, an interconnection portion 30, and a wiring terminal portion 32 are arranged in the non-display area NAA. The pixel circuit 22 includes gate lines (scanning lines) that transmit scanning signals, source lines (signal lines) that transmit image signals, and thin film transistors (TFT) that are switching elements connected to the gate lines and source lines. The gate lines are provided as metal films, such as Ag films and Al films, and extend in the X-axis direction. A number of the gate lines are thus arranged at intervals along the Y-axis direction. The source lines are provided as metal films that are arranged on an upper layer side to the gate lines via a gate insulating film 34 (see FIG. 5), and extend in the Y-axis direction. A number of the source lines are thus arranged at intervals along the X-axis direction. The TFTs are transistors of a known structure having a channel made of a semiconductor film, etc., and are connected to the pixel electrodes 24. The TFTs are driven by scanning signals transmitted to the gate lines, and supply image signals transmitted to the source lines, to the pixel electrodes 24 via channels, thereby charges the pixel electrodes 24 to give them a given potential. The TFTs and the pixel electrodes 24 are placed in an area encircled with the gate lines and the source lines such that a number of the TFTs and the pixel electrodes 24 are arranged along the X-axis direction and the Y-axis direction in a matrix formation.

Each pixel electrode 24 as well as the common electrode 26 is made of a transparent electrode film. The pixel electrodes 24 are arranged on an upper layer side with respect to the common electrode 26 while having a transparent inter-electrode insulating film (inter-layer insulating film) 36 therebetween. The common electrode 26 as a whole is equal in size to the display area AA but is divided into latticed segments. These latticed segments (a plurality of touch electrodes) overlap the plurality of pixel electrodes 24 and are connected to the driver 14. The common electrode 26 is supplied with a substantially constant reference voltage at least during display of an image, and has a potential difference with the pixel electrodes 24 which are charged to have a higher potential. An electric field created by the potential difference between the common electrode 26 and the pixel electrodes 24 includes a component along the surface of the array substrate 12B and includes also a fringe field (oblique electric field) including a component in the direction of a normal to the surface of the array substrate 12B. The liquid crystal panel 10 thus operates in so-called fringe field switching (FFS) mode in which the orientation of liquid crystal molecules making up the liquid crystal layer 12C is controlled using the fringe field. When no image is displayed, the common electrode 26 functions as an electrode that detects a change in capacitance caused by position input, and the driver 14 to which the electrode is connected calculates a change in capacitance. This gives the liquid crystal panel 10 an in-cell touch panel function for identifying an input position in the display area AA.

To the plurality of touch electrodes making up the common electrode 26, a plurality of touch lines (position detecting lines) 38 formed in the array substrate 12B are selectively connected. The touch lines 38 extend along the Y-axis direction in the array substrate 12B in such a way as to overlap and run parallel with the source lines, and are connected selectively to specific touch electrodes among the plurality of touch electrodes arranged in the Y-axis direction. The touch lines 38 are connected also to the driver 14.

The peripheral circuit 28 is composed of circuit elements, such as lines made of the same metal films making up the gate lines and source lines and TFTs made of the same semiconductor films making up the channels. The peripheral circuit 28 is disposed in such a way as to substantially encircle the whole of the display area AA along its four sides, i.e., entire periphery. As shown in FIG. 2, the peripheral circuit 28 is located inwardly relative to the seal 12D (located closer to the display area AA than the seal 12D) in the non-display area NAA and is therefore disposed in a location where the peripheral circuit 28 does not overlap the seal 12D in a plan view. The peripheral circuit 28 is connected to the driver 14 through connection lines provided in the non-display area NAA of the array substrate 12B.

The interconnection portion 30 connects lines, source lines, etc., included in the peripheral circuit, to connection lines made of metal films in a different layer. The interconnection portion 30 has contact holes formed as openings that penetrate insulating films interposed between metal films to connect lines to each other. In the non-display area NAA, the interconnection portion 30 is located closer to the outside than the peripheral circuit 28. The interconnection portion 30 is disposed such that most of the interconnection portion 30 overlaps the seal 12D in a plan view. The wiring terminal portion 32 is disposed on the CF substrate non-overlapping portion 12B1 of the array substrate 12B, and has a plurality of terminals and lines for connection to the driver 14 and the flexible board 16, which terminals and lines will be described in detail later.

On an upper layer side to the pixel circuit 22, the peripheral circuit 28, and the interconnection portion 30 in the array substrate 12B, a first flattening film 40a and a second flattening film 40b are formed. In the array substrate 12B, the first flattening film 40a and the second flattening film 40b are formed substantially as solid films extending in the whole area located inwardly relative to the seal 12D. Each of the first flattening film 40a and the second flattening film 40b is made of, for example, an organic material, such as an acrylic resin (e.g., PMMA), and has a function of flattening a level difference having developed on a lower layer side to the first flattening film 40a and the second flattening film 40b. The first flattening film 40a is overlaid directly on the pixel circuit 22, the peripheral circuit 28, and the interconnection portion 30, and is overlaid with the above-mentioned touch lines 38 formed on an upper layer side to the first flattening film 40a. The second flattening film 40b is formed in a location that is an upper layer side to the touch lines 38 and a lower layer side to the above-mentioned common electrode 26. Both first flattening film 40a and second flattening film 40b have contact holes formed as openings for connecting the pixel electrodes 24, etc., to the pixel circuit 22 in the display area AA.

The internal structure of the CF substrate 12A will then be described. In the CF substrate 12A, a base coat 42 is formed on a substantially transparent glass substrate, and on the base coat 42, color filters 44 are provided in a location where the color filters 44 overlap the pixel electrodes 24, respectively, in the display area AA. The color filters 44 are filters of three colors, i.e., red, green, and blue, that are arranged alternately along the X-axis direction and that extend along the Y-axis direction. The color filters 44 are thus provided as an array of strip-shaped filters as a whole. Inside the CF substrate 12A in the Z-axis direction, a shading portion (black matrix) 46 that partitions adjacent color filters 44 from each other to prevent color mixing, etc., is provided in a range extending from the non-display area NAA to the display area AA. The shading portion 46 is latticed in the display area AA in which the latticed shading portion 46 overlap the gate lines and source lines, but is solid in the non-display area NAA. On an upper layer side to the color filter 44 and the shading portion 46, an overcoat film (counter insulating film) 48 is formed. The overcoat film 48 is formed substantially as a solid film extending in the whole range located inside relative to the seal 12D in the CF substrate 12A. Similar to the flattening films 40a and 40b, the overcoat film 48 is made of, for example, an organic material, such as an acrylic resin (e.g., PMMA), and has a function of flattening a level difference having developed on a lower layer side to the overcoat film 48.

A CF-side alignment film (counter alignment film) 50A for orienting liquid crystal molecules included in the liquid crystal layer 12C is provided on the innermost surface of the substrate 12A, the innermost surface being in contact with the liquid crystal layer 12C, while an array-side alignment film (alignment film) 50B for orienting liquid crystal molecules included in the liquid crystal layer 12C is provided on the innermost surface of the substrate 12B, the innermost surface being in contact with the liquid crystal layer 12C. Each of the CF-side alignment film 50A and the array-side alignment film 50B is made of, for example, polyimide, which is an organic material. The CF-side alignment film 50A is formed on an upper layer side to the overcoat film 48 and is overlaid on the overcoat film 48 to cover it entirely at least in the display area AA. The array-side alignment film 50B is formed on an upper layer side to the pixel electrodes 24 and is overlaid on the pixel electrodes 24 to cover them entirely at least in the display area AA. In the liquid crystal panel 10, the CF-side alignment film 50A and the array-side alignment film 50B are formed as solid films extending substantially in the whole range located inside relative to the seal 12D in the Y-axis direction.

Members connected to the liquid crystal panel 10 will hereinafter be described. The flexible board 16 has a base material made of a synthetic resin material, such as a polyimide-based resin, having insulation property and flexibility, and a number of wiring patterns formed on the base material. The flexible board 16 is mounted on the array substrate 12B by a film on glass (FOG) mounting process. The flexible board 16 has one end connected to a flexible board mounting portion 56 formed on the array substrate 12B and the other end connected to a control circuit board. This allows transmitting an input signal coming from the control circuit board to the liquid crystal panel 10.

The driver 14 is composed of an LSI chip having a built-in drive circuit, and operates based on a signal supplied by the control circuit board, which is a signal supply source. The driver 14 processes an incoming signal from the control circuit board to create an output signal, and sends the output signal to the display area AA of the liquid crystal panel 10. The driver 14 is of a laterally elongated rectangle (rectangle elongated along the short sides of the liquid crystal panel 10) in a plan view, and is mounted on the array substrate 12B by a chip on glass (COG) mounting process.

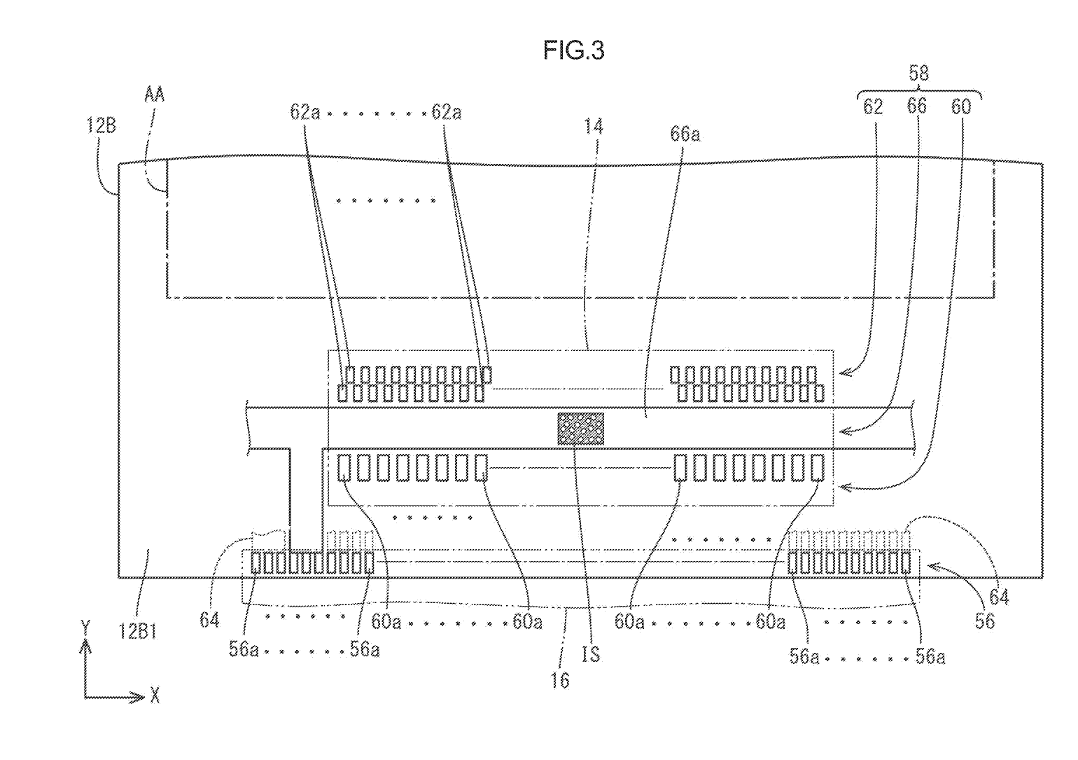

A terminal connection structure of the driver 14 and the flexible board 16 to the non-display area NAA of the array substrate 12B will then be described. As shown in FIG. 1, the CF substrate non-overlapping portion 12B1 in the non-display area NAA of the array substrate 12B is provided with the flexible board mounting portion 56 for mounting the flexible board 13, which flexible board mounting portion 56 is disposed on the outer periphery of the CF substrate non-overlapping portion 12B1, and with a driver mounting portion 58 for mounting the driver 14, which driver mounting portion 58 is located between the flexible substrate mounting portion 56 and the display area AA. The flexible board mounting portion 56 of the array substrate 12B is a terminal portion that is supplied with incoming signals and power from the flexible board 16 (that outputs signals from the flexible board 16 to the driver 14), and is made up of a plurality of terminals 56a arranged at intervals along the X-axis direction, as shown in FIG. 3.

The driver mounting portion 58 of the array substrate 12B includes a driver input terminal portion 60 for inputting signals from the flexible board 16 to the driver 14, and a driver output terminal portion 62 for outputting signals from the driver 14 to the display area AA of the liquid crystal panel 10. The driver input terminal portion 60 is made up of a plurality of terminals 60a arranged at intervals along the X-axis direction, and, similarly, the driver output terminal portion 62 is made up of a plurality of terminals 62a arranged at intervals along the X-axis direction. Some terminals 56a of the flexible board mounting portion 56 are electrically connected to terminals 60a of the driver input terminal portion 60 through connection lines 64 formed to provide a route connecting the flexible board mounting portion 56 to the driver mounting portion 58.

The driver mounting portion 58 further includes a ground portion 66 which is disposed between the driver input terminal portion 60 and the driver output terminal portion 62 and suppresses noise radiated from the driver 14. The ground portion 66 is composed mainly of a ground line 66a, which is a line for grounding that extends between the plurality of terminals 60a of the driver input terminal portion 60 and the plurality of terminals 62a of the driver output terminal portion 62 in such a way as to be parallel with the direction (X-axis direction) in which the terminals 60a and 62a are arranged. The ground line 66a is connected to some terminals 56a of the flexible board mounting portion 56, as shown in FIG. 3, and extends toward the display area AA.

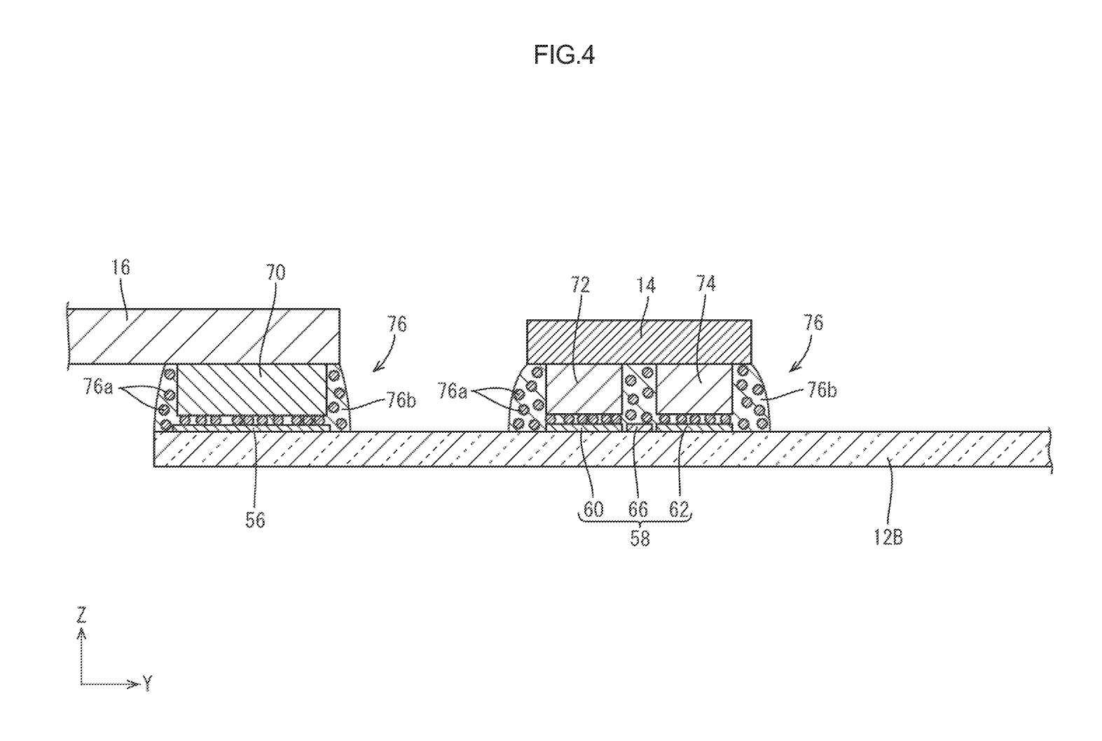

As shown in FIG. 4, one end of the flexible board 16 is provided with a flexible board output bump 70 composed of a plurality of terminals electrically connected to the flexible board mounting portion 56 of the array substrate 12B. The driver 14 has a driver input bump 72 serving as an input terminal portion electrically connected to the driver input terminal portion 60 of the array substrate 12B, and a driver output bump 74 serving as an output terminal portion electrically connected to the driver output terminal portion 62 of the array substrate 12B. Between the driver 14 and flexible substrate 16 and the array substrate 12B, an anisotropic conductive film (ACF) 76 is interposed. The ACF 76 is composed of a number of conductive particles 76a and a binder 76b in which the conductive particles 76a are dispersed. The terminal portions 56, 60, and 62 on the array substrate 12B are electrically connected to the bumps 70, 72, and 74 of the flexible substrate 16 and driver 14 through the conductive particles 76a.

The structure of the driver mounting portion 58 of the array substrate 12B will then be described in detail, referring to FIG. 5. The base coat 20, which is manufactured by a process of manufacturing an overlapping portion where the array substrate 12B and the the CF substrate 12A overlap, and the gate insulating film 34, which is manufactured by a process of manufacturing the pixel circuit 22 and the peripheral circuit 28, are formed also in the driver mounting portion 58 of the array substrate 12B. On an upper layer side to the gate insulating film 34, a first metal film 80 made of the same material making up the gate lines, source lines, etc., is disposed. On an upper layer side to the first metal film 80, a first insulating film 82 and a second metal film 84 which are made of the same material making up the gate insulating film, etc., are disposed. On an upper layer side to the second metal film 84, a second insulating film 86 and a transparent conductive film 88 are disposed.

On each of the driver input terminal portion 60 and the driver output terminal portion 62, the first metal film 80, the second metal film 84, and the transparent conductive film 88 are formed but the first insulating film 82 and the second insulating film 86 are not formed. The first metal film 80, the second metal film 84, and the transparent conductive film 88 are connected together to make up the terminals 60a and 62a of the driver input terminal portion 60 and driver output terminal portion 62. Meanwhile, no first metal film 80 is disposed on the ground portion 66, on which only the second metal film 84 is disposed. This second metal film 84 makes up the above ground line 66a. In other words, the second metal film 84 serves as a metal film for the ground line.

The ground portion 66 (to be exact, a part of second metal film 84 that makes up the ground line 66a) carries an identification symbol IS for identifying the liquid crystal panel 10. Specifically, as shown in FIG. 3, the identification symbol IS is formed on the part of second metal film 84 that makes up the ground line 66a, by forming a plurality of through-holes on the second metal film 84 and removing a part of the second metal film 84 where the through-holes are formed. The identification symbol IS is a two-dimensional bar code formed of a combination of the through-holes, capable of conveying a relatively large amount of information.

According to the liquid crystal panel 10 configured in the above manner, the identification symbol IS is placed in an area of the array substrate 12B in which the driver 14 is mounted. This allows effective use of a space on the CF substrate non-overlapping portion 12B1 of the array substrate 12B. In recent years, a panel frame for the display panel has been reduced in size. Under such a circumstance, a problem with placement of the identification symbol IS does not arise when the driver 14 is mounted on the substrate because the identification symbol IS is placed in the area in which the driver 14 is mounted. According to the liquid crystal panel 10, even if the panel frame for the display panel is further reduced in size, the identification symbol IS can certainly be provided in the case where the driver 14 is mounted on the substrate.

The identification symbol IS is formed by removing a part of the second metal film 84 and forming the through-hole on the part, and, as shown in FIG. 5, an upper layer side to the ground line 66a carrying the identification symbol IS is overload with the transparent conductive film 88 only and has only the transparent films provided on a lower layer side to the ground line 66a, the transparent films being the first insulating film 82, the gate insulating film 34, the base coat 20, and the transparent glass substrate. Because of this configuration, before the driver 14 is mounted, the identification symbol IS can be visually recognized from both the front side and back side. In other words, even after the driver 14 is mounted, the identification symbol IS can be visually recognized from the back side.

According to the liquid crystal panel 10, the ground line 66a having the identification symbol IS formed thereon is covered with the transparent conductive film 88. This prevents noise leakage from the ground line 66a and stabilizes the potential of the ground line 66a having lost a part thereof as a result of formation of the identification symbol IS.

### Second Embodiment

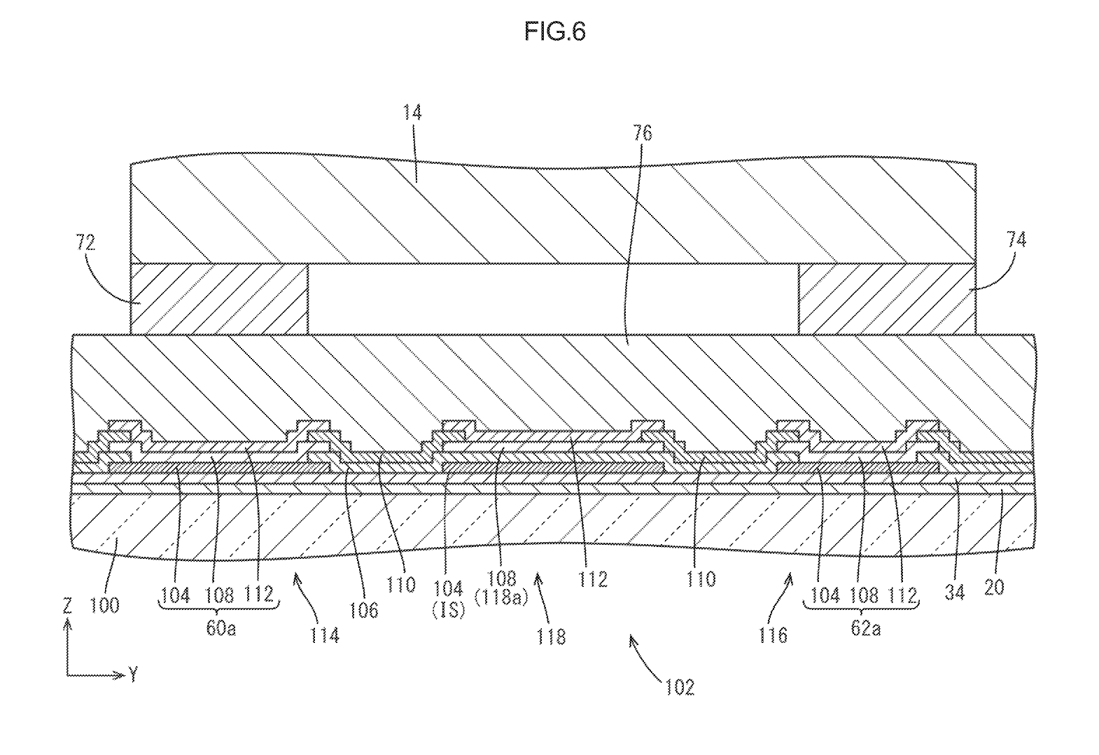

A liquid crystal panel according to a second embodiment will be described, referring to FIG. 6. An array substrate 100 included in the liquid crystal panel according to the second embodiment is different from the array substrate 12B included in the liquid crystal panel 10 according to the first embodiment in the structure of the driver mounting portion and in the location where the identification symbol IS is formed. For this reason, description of the liquid crystal panel according to the second embodiment will be limited to description of a driver mounting portion 102 the array substrate 100 has. The same constituent elements as those of the liquid crystal panel 10 according to the first embodiment will be denoted by the same reference numerals and will be omitted in further description.

Similar in structure to the driver mounting portion 58 according to the first embodiment, the driver mounting portion 102 according to the second embodiment has a first metal film 104, a first insulating film 106, a second metal film 108, a second insulating film 110, and a transparent conductive film 112 that are stacked in order on an upper layer side to the gate insulating film 34. A driver input terminal portion 114 and a driver output terminal portion 116, which make up the driver mounting portion 102, have the same structure as that of the driver input terminal portion and the driver output terminal portion according to the first embodiment, but a ground portion 118 has a structure different from that of the ground portion according to the first embodiment. Specifically, according to the second embodiment, the ground portion 118 includes also the first metal film 104 and the second metal film 108. The second metal film 108 formed on an upper layer side in the ground portion 118 makes up a ground wring line 118a. In other words, the second metal film 108 serves as a metal film for the ground line.

The first metal film 104 formed on a lower layer side in the ground portion 118 carries the identification symbol IS formed in the same manner as the identification symbol according to the first embodiment. This means that, according to the second embodiment, the identification symbol IS is formed on the metal film different from the metal film for the ground line and that the first metal film 104 serves as a metal film for the identification symbol. According to the second embodiment, therefore, because of the presence of the second metal film on the upper layer side to the first metal film 104, the identification symbol IS can be visually recognized from the back side only. However, because the identification symbol IS and the ground line 118a are formed respectively on different metal films, the potential of the ground line 118a can be stabilized. According to the second embodiment, obviously, the identification symbol IS can be visually recognized from the back side after the driver 14 is mounted, as in the first embodiment.

### Third Embodiment

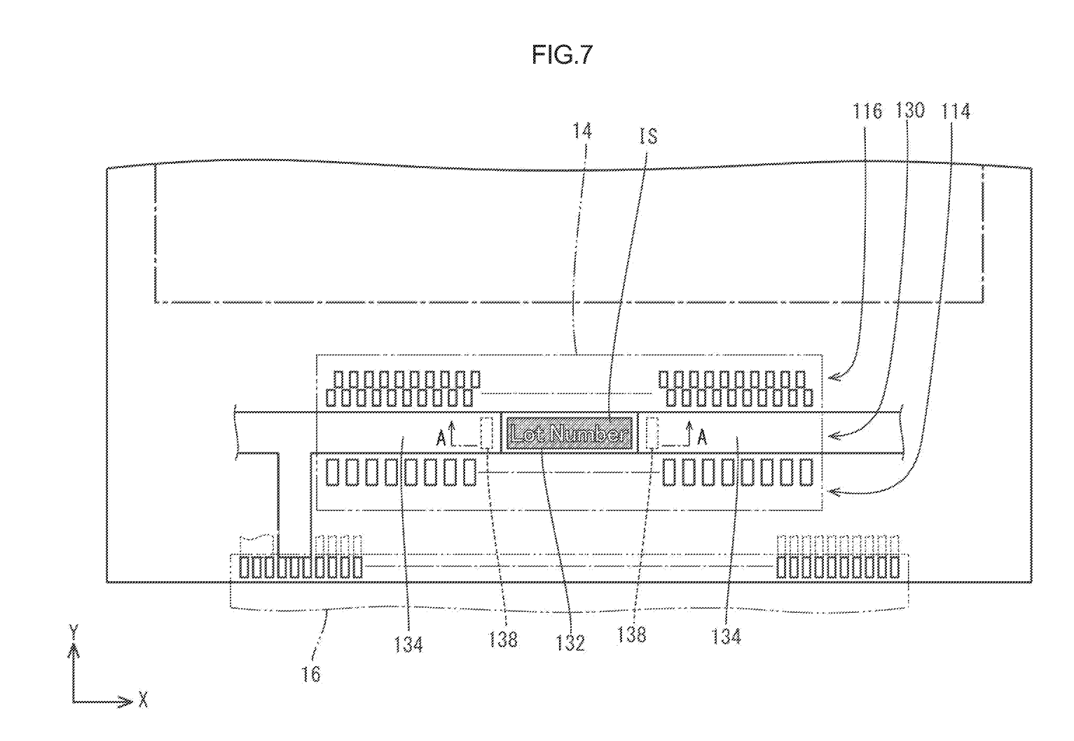

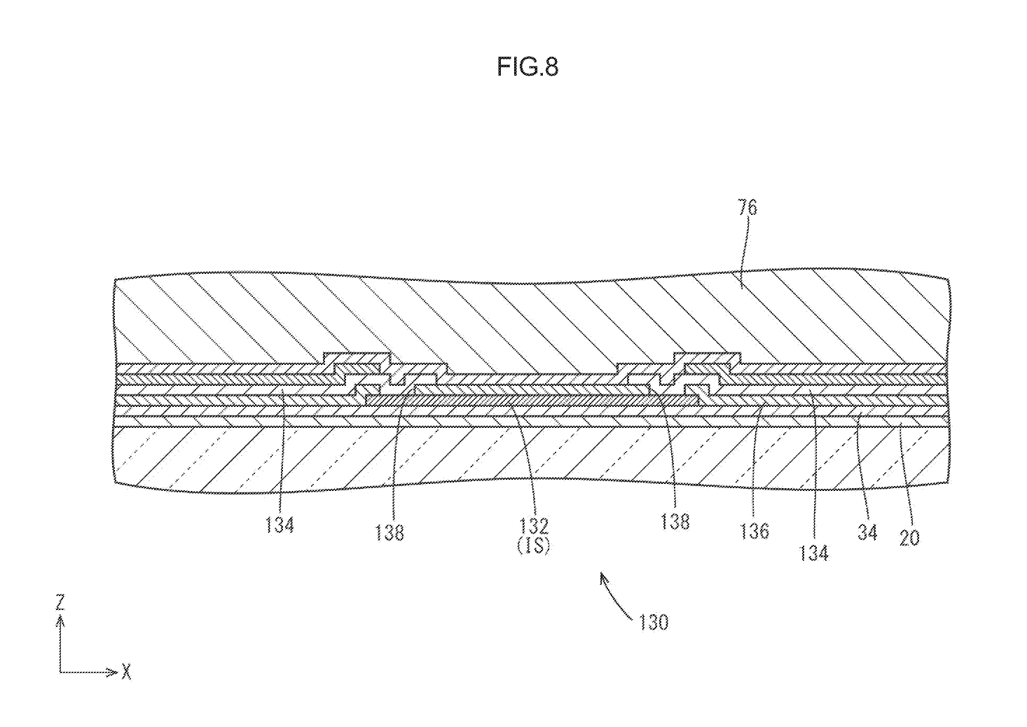

A liquid crystal panel according to a third embodiment will be described, referring to FIGS. 7 and 8. FIG. 8 illustrates a section taken along an A-A line in FIG. 7, showing a sectional view seen in a direction perpendicular to a direction in which the grounding lines extend. The liquid crystal panel according to the third embodiment is similar to the liquid crystal panel according to the second embodiment. The liquid crystal panel according to the third embodiment is different from the liquid crystal panel according to the second embodiment only in the structure of the ground portion. A ground portion 130 according to the third embodiment will therefore be described.

Similar in structure to the ground portion 118 according to the second embodiment, the ground portion 130 of the liquid crystal panel according to the third embodiment includes a first metal film 132 and a second metal film 134, and the first metal film 132 on a lower layer side carries the identification symbol IS. According to the third embodiment, a part of the first metal film 132 is removed to shape a lot number in place of a two-dimensional bar code.

As shown in FIGS. 7 and 8, the second metal film 134 making up a ground line 130a has its middle part in the direction of extension of the ground line 130a removed, being divided at the middle part. At the middle part where the second metal film 134 is divided, the first metal film 132 is disposed on a lower layer side. Respective ends of divided pieces of the second metal film 134 and the first metal film 132 are arranged such that the ends overlap the first metal film 132, and contact holes 138 are formed on a first insulating film 136 such that the contact holes 138 are located respectively on parts where the ends overlap the first metal film 132. Through these contact holes 138, therefore, the first metal film 132 and the second metal film 134 are connected to each other. In other words, the divided ground line 130a is connected to the first metal film 132.

As a result, according to the liquid crystal panel of the third embodiment, the second metal film 134 is not present on an upper layer side to a part where the identification symbol IS is formed. This allows the identification symbol IS to be visually recognized not only from the back side but also from the front side, as shown in FIG. 7.

The above three embodiments relate to the liquid crystal panel that operates in the FFS mode. However, the present technology applies also to liquid crystal panels that operate in IPS mode, TN mode, and VA mode, respectively, and to an organic EL panel as well. According to the above three embodiments, the identification symbol is disposed on the ground portion. The identification symbol, however, may be disposed on a part of the driver input terminal portion or the driver output terminal portion or may be disposed on a part extending over two of the ground portion, the driver input terminal portion, and the driver output terminal portion. In other words, the identification symbol may be disposed on any part within the driver mounting portion.

1. A display panel comprising:
a first substrate;
a second substrate that is pasted together with the first substrate so as to overlap the first substrate and is larger than the first substrate; and
a driver mounting portion included in a part of the second substrate so as not to overlap the first substrate and on which a driver for driving the display panel is mounted, and the driver mounting portion having an identification symbol for identifying the display panel.

2. The display panel according to claim 1, wherein
the driver mounting portion includes a metal film, and
the identification symbol is formed by removing a part of the metal film and forming through-holes on the part.

3. The display panel according to claim 2, wherein the identification symbol is a two-dimensional bar code formed of a combination of a plurality of through-holes.

4. The display panel according to claim 1, wherein
the driver mounting portion includes
a driver input terminal portion for connection to an input terminal of the driver,
a driver output terminal portion for connection to an output terminal of the driver, and
a ground portion disposed between the driver input terminal portion and the driver output terminal portion and the ground portion being used for suppressing noise radiated from the driver, and
the identification symbol is formed on the ground portion.

5. The display panel according to claim 4, wherein
the ground portion includes a metal film for ground line that makes up a line for grounding and a transparent conductive film covering the metal film for ground line and being electrically connected to the metal film for ground line, and
the identification symbol is formed by removing a part of the metal film for ground line and forming through-holes on the part.

6. The display panel according to claim 4, wherein
the ground portion includes a metal film for ground line that makes up a line for grounding and a metal film for identification symbol that is different from the metal film for ground line, and
the metal film for identification symbol is used to form the identification symbol.

7. The display panel according to claim 6, wherein the metal film for identification symbol is disposed closer to the second substrate than the metal film for ground line.
